(19) United States
(12) Patent Application Publication
(10) Pub. No.: US 2002/0083200 A1
(43) Pub. Date: Jun. 27, 2002

(54) Dynamic resource mapping in a TCP/IP environment

(75) Inventors: Jens Haulund, Trumbull, CT (US); Donald S. Denton, North Haven, CT (US); Graham Yarbrough, Sandy Hook, CT (US)

Correspondence Address: BAKER & HOSTETLER LLP, Washington Square, Suite 1100, 1050 Connecticut Avenue, N.W., Washington, DC, 20036, US

(73) Assignee: Inrange Technologies Corporation

(21) Appl. No.: 10/024,564

(22) Filed: Dec. 21, 2001

Related U.S. Application Data
(60) Provisional application No. 60/258,437, filed on Dec. 27, 2000.

(51) Int. Cl. G06F 15/16

(52) U.S. Cl. 709/245; 709/203

(57) ABSTRACT

An apparatus and method for dynamic resource mapping in a TCP/IP environment that includes a DRM server component, a client side DRM process for collecting machine specific performance characteristics, a client/server protocol to allow communication of machine specific process characteristics between the DRM server component and the client side DRM process and a DRM protocol to allow a client to request an application resource by name and the DRM server to return a selected address of a client, the selection made based upon collected machine specific performance characteristics of at least one client. Furthermore, the invention updates the DRM server to reflect the operability of the application and as a result does not return the address of the resource if it is inoperable.

### PRIORITY

This application claims priority to the provisional U.S. patent application entitled, DYNAMIC RESOURCE MAPPING IN A TCP/IP ENVIRONMENT, filed Dec. 27, 2000, having a Ser. No. 60/258,437, the disclosure of which is hereby incorporated by reference.

### FIELD OF THE INVENTION

The present invention relates generally to domain name system mapping. More particularly, the present invention relates to dynamic domain system mapping to resources.

### BACKGROUND OF THE INVENTION

The Domain Name System (DNS) enables a user or process to ask for a host (computer) by name without having to know the Internet Protocol (IP) address of this host. A common example of DNS is the IP address lookup for www.inrange.com that results in the following sequence of two IP datagrams:

DNS name query “www.inrange.com” is sent to a DNS server as configured in the IP host's gateway statement.

DNS_name response “www.inrange.com is on IP address 192.1.1.1” is the reply from the DNS server.

The current well-defined and understood concepts of DNS can be found in RFC 1035 Domain Names-Implementation and Specification, P. Mockapetris, November, 1987, which is further enhanced in several additional RFC's, particularly RFC 2136 Dynamical Updates in the Domain Name System (DNS UPDATE), P. Vixie, et al.

FIG. 1 illustrates the basic implementation of the DNS Protocol logic. Using the DNS protocol described above, a user/DNS requester 2 is able to ask for a host computer by name rather than having to know the IP address of this host. As an example, the user/DNS requester 2 requests a host selected from among IP hosts 3, 4, 5 and 6, on an IP network having an IP network name “customer.com.” The user/DNS requester 2 sends a message to the DNS server 1 with a DNS request for an IP address corresponding to the name of the requested host. The DNS server maintains a table of hostnames and one or more IP addresses associated with each hostname. The DNS server 1 receives the request from the user/requester 2, and, using the table of host names, resolves the hostname to a corresponding IP address. The DNS server 1 then sends a reply to the user/requester 2 containing the IP address.

In the present example, a hostname lookup of “host1.customer.com” returns IP address 192.1.1.1. A hostname lookup of “allhosts.customer.com” returns one of the four listed IP addresses.

The reason that more than one IP address is associated with a given hostname is to allow for multiple physical processors to deal with incoming requests to the hostname. Thus, the DNS server 1 responds to a request for hostname “customer.com” with any one of IP hosts 3, 4, 5 and 6. With the DNS protocol logic described, a simple round-robin assignment of a physical processor takes place.

As currently implemented, DNS possesses a number of limitations. For one, a physical processor could be taken off-line or otherwise fail, but the table maintained by the DNS server would not reflect this. Subsequent requests for the specific hostname would continue to be directed to the off-line server, and only manual intervention by the DNS administrator (removing the IP address of the failed server from the table) would resolve the issue.

Also, there is no way to prioritize the assignment of physical processors. If there are 10 processors with the same hostname but with individual IP addresses, the DNS logic does not provide a mechanism to direct more requests to the most powerful or available of these processors.

### SUMMARY OF THE INVENTION

The present invention relates to methods and systems for dynamically distributing workloads across multiple IP hosts using Dynamic Resource Mapping (DRM) logic. DRM implementation is fully compatible with existing DNS as far as the users are concerned, but behind the scenes, the DRM logic maintains detailed information about the hosts it provides DNS service for. This detailed information comprises processor specific information, such as CPU utilization, disk utilization, and other system-wide parameters. Furthermore, DRM provides for application level resource information such as database table names.

Using the DRM logic, workloads may be distributed according to the availability and processing characteristics of the IP hosts. DRM promotes the efficient management of processing power across multiple machines, and increases the aggregate throughput of processing requests.

DRM allows users to request processing resources on a DRM-supported IP host by process name and/or characteristics rather than by IP hostname.

DRM also enables automatic error recovery in the event that an IP host becomes unavailable. DRM is dynamic in that it is capable of obtaining updated data regarding the processes and resources available from a plurality of DRM-supported IP hosts.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a block diagram illustrating the prior art DNS protocol;

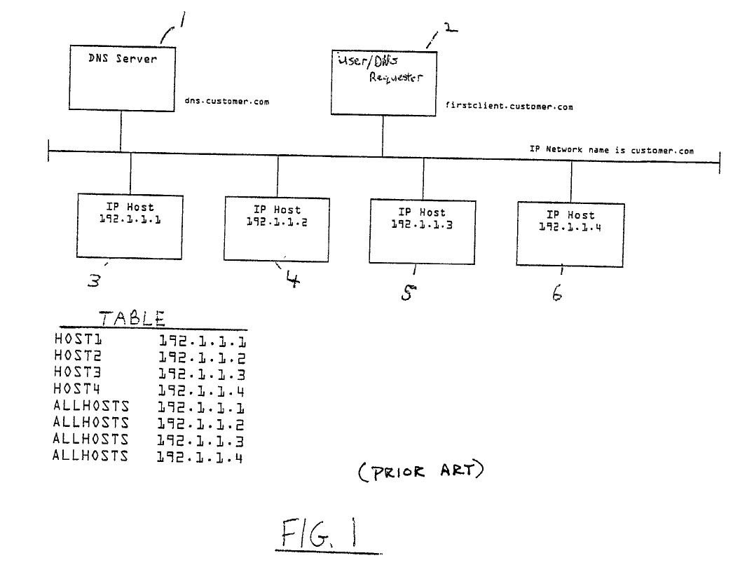

FIG. 2 is a block diagram illustrating an implementation of DRM according to the principles of the present invention;

FIG. 3 is a process flow diagram illustrating an embodiment of the initialization of a DRM process as employed in the implementation of FIG. 2;

FIG. 4 is a process flow diagram illustrating DRM component and DRM client operation interaction operating in the implementation of FIG. 2;

FIG. 5 is a process flow diagram illustrating the operation of a DRM process as between a user and DNS/DRM server of FIG. 2; and

FIG. 6 is a block diagram illustrating an application of a DRM process as shown and described in FIGS. 2-5.

### DETAILED DESCRIPTION OF PREFERRED

Embodiments of the Invention

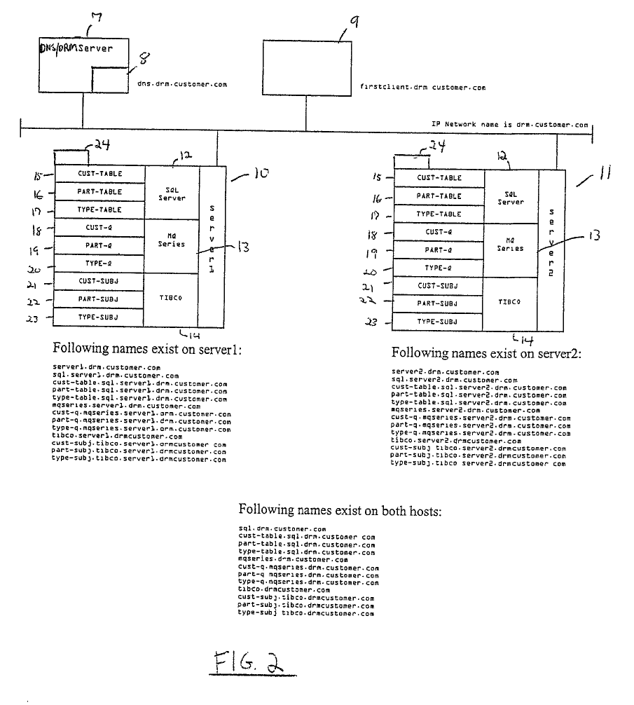

Turning now the drawings, FIG. 2 illustrates a network implementing Dynamic Resource Mapping (DRM), the network comprising a DNS/DRM server 7, containing a DRM component 8, a user (i.e. requesting DRM client) 9, and DRM clients (i.e. DRM-supported IP hosts) 10, 11.

The DRM clients comprise application processes (such as SQL application processes 12, MQ series application processes 13, and TIBCOTM application processes 14), application resources (such as cust-table 15, part-table 16, type-table 17, cust-Q 18, part-Q 19, type-Q 20, cust-subj 21, part-subj 22, type-subj 23), and DRM process 24.

The DRM protocol of the present invention operates in essentially the same manner as DNS (with which it is compatible), but the DRM logic allows the user to request processing resources on a host computer by processing name and/or characteristics rather than by hostname. For example, user 9 may request “cust-table.sql.server1.drm.customer.com” for a specific application resource on a specific host machine. Alternatively, the user may request “cust-table.sql.drm.customer.com,” and the DNS/DRM server 7 will return an IP address for one of any number of hosts providing the requested application resource. The difference is that the subname “server 1”is omitted when the user, which, again, may be an automated process, wants to allow the DNS/DRM server 7 to select a client 10, 11 in an automated manner according to selection criteria, as described below.

The DNS/DRM server 7 further comprises a DRM component 8, which maintains the DRM table and implements the DRM logic. The DRM component 8 performs the lookup function for the DNS/DRM server 7 based upon metrics received from the DRM processes 24 operating on the DRM clients 10, 11. The metrics generally relate to efficiency concerns, such as the availability of application components, processing load, processing speed, memory, location of DRM client, etc. Using this information, the DRM component 8 is able to select the best available DRM client to handle the user request. The DNS/DRM server 7 is thus able to efficiently distribute workload across multiple IP hosts.

The DRM protocol is dynamic in that the DRM component 8 and the DRM processes 24 communicate with each other over time, and the DRM-related metrics provided by the DRM processes 24 can be updated when necessary. The DRM protocol may include a “failsafe” feature so that the DNS/DRM server 7 will stop returning the IP addresses of DRM clients 10, 11 that have been taken off-line or have otherwise failed. This may be accomplished by the DRM component 8 “polling” the available DRM clients 10, 11 from time to time. Alternatively, the DRM processes 24 on the DRM client 10, 11 may be programmed to signal the DNS/DRM server 7 from time to time. The DRM component 8 is programmed to stop returning the IP address of a DRM client 10, 11 when the signaling stops for a sufficient time interval.

Additionally, the DRM processes 24 may be programmed to automatically register with the DRM component when the respective DRM client 10, 11 comes on-line and/or when the respective DRM client is available to handle particular user requests. DRM-supported clients can be easily added and removed based upon the demand for application components.

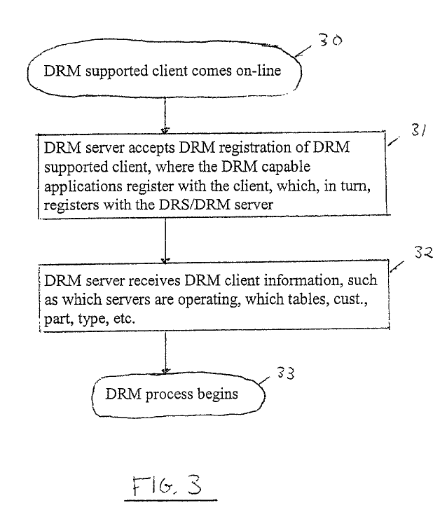

Turning now to FIG. 3, the initialization of the DRM process is illustrated by way of a flow diagram. In Step 30, a DRM supported client comes on-line. In Step 31, the DNS/DRM server accepts registration of the on-line DRM client, where the DRM capable applications register with the client, which, in turn, registers with the DNS/DRM server. In Step 32, the DNS/DRM server receives DRM client information, such as which application servers are running and which application resources are available (cust.-table, part-table, type-table, etc.). In Step 33, the DRM process begins. The initialization process occurs for each DRM supported client serviced by the DNS/DRM server.

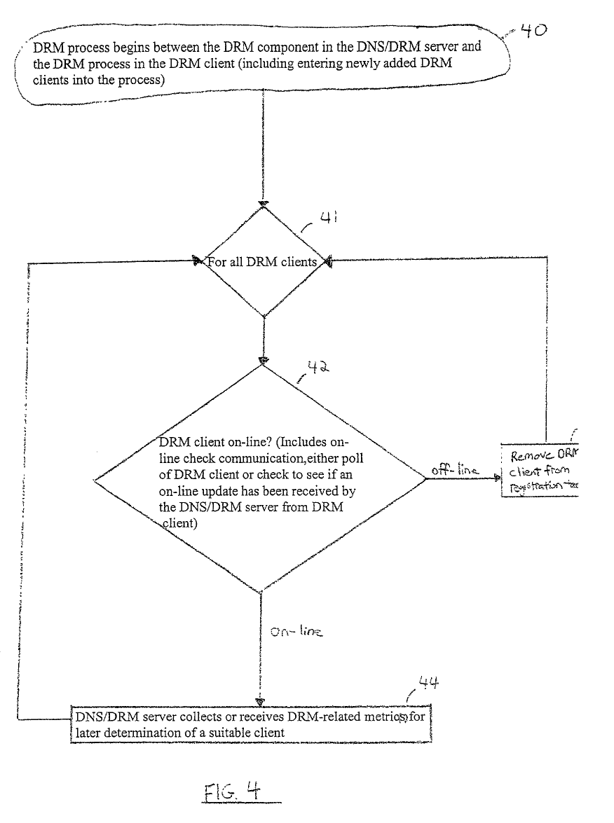

FIG. 4 illustrates DRM component and DRM client operation interaction. In Step 40, a DRM process begins between a DRM component residing in the DNS/DRM server and the DRM process in a registered DRM client. In Steps 41 and 42, for all DRM clients, it is determined whether the DRM client is on-line. The step of determining whether a DRM client is on-line includes an on-line check communication between the DNS/DRM server land the DRM client. This communication can be, for example, a poll of the DRM client by the DNS/DRM server, or, alternatively, a check to see an on-line update communication has been received by the DNS/DRM server from the DRM client. If it is determined that a DRM component is off-line, in Step 43 the DRM client is removed from a registration table maintained by the DRM component. The process is then repeated from Step 41. If instead it is determined that the DRM client is on-line, in Step 44, the DNS/DRM server requests or receives DRM-related metric(s) for later determination of a suitable client to handle a request. The process is then repeated from Step 41.

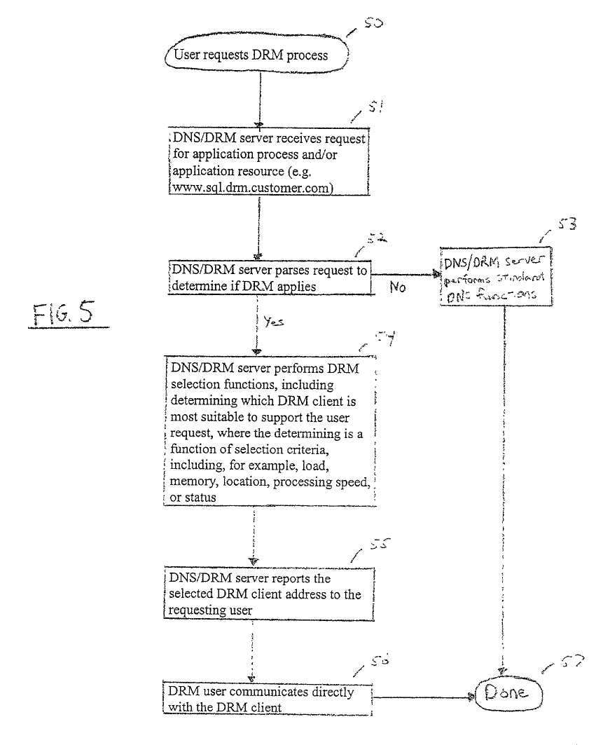

FIG. 5 is a process flow diagram of a DRM process in operation. In Step 50, a user (i.e. DNS requester) requests a DRM process. In Step 51, the DNS/DRM server receives a request for an application process and/or application resource (e.g. www.sql.drm.customer.com) from the user. In Step 52, the DNS/DRM server parses the request to determine if DRM applies. If DRM does not apply, in Step 53 the DNS/DRM server performs standard DNS functions, and the process is done 57. If DRM does apply, in Step 54 the DNS/DRM server performs selection functions, including determining which DRM client is most suitable to support the user request, where the determining is a function of selection criteria, including, for example, load, memory, location of the client, processing speed and status. In Step 55, the DNS/DRM server reports the selected DRM client address to the requesting user. In Step 56, the DRM user communicates directly with the DRM client, and the process is done 57.

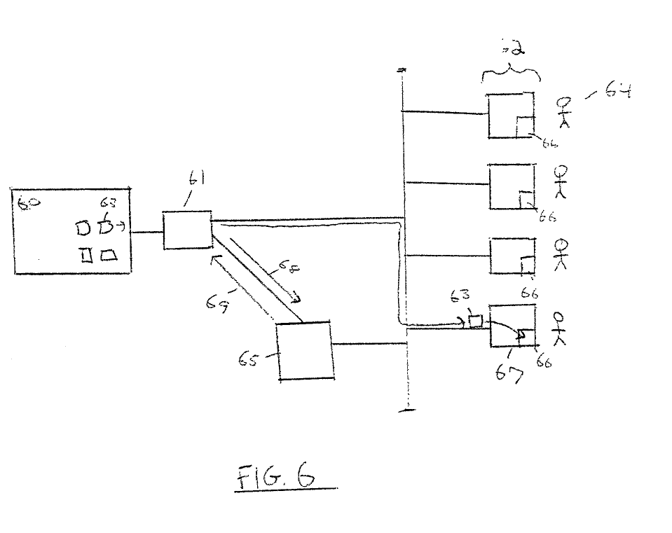

FIG. 6 illustrates one application of the present invention. An IBM® mainframe 60 computer, through a DRM-supported requester 61, issues a plurality of DRM requests for application components located on a plurality of DRM-supported servers 62. In the specific example, the requests comprise customer service requests 63 to customer service representatives 64. The DRM-supported requester 61 issues requests 68 to the DNS/DRM server 65 for application components, specifically message queue server process, such as used by the MQ server series made by Inrange™, and/or resources 66, to handle each customer service request 63. Using a DRM process, as outlined above, the DNS/DRM server 65 determines the DRM-supported server best able to handle each request for MQ series processes and/or resources 66, and returns an address 69 corresponding to the selected server 67. The DRM-supported requester 61 then communicates directly with the selected server 67, and the selected server processes the MQ series request. Using DRM, the customer service requests 63 can be evenly distributed to and efficiently processed by the customer service representatives 64.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method for dynamic resource mapping (DRM), comprising:
receiving a DRM request for an application resource, including a process or data handler, from a user;
selecting a suitable DRM client from among plural registered DRM clients having the application resource to support the user request; and
providing an address corresponding to the application resource on the selected DRM client to the user.

2. The method according to claim 1, further comprising accepting a DRM registration of a DRM supported client.

3. The method according to claim 2, wherein the step of accepting a DRM registration is accomplished with a DRM server.

4. The method according to claim 3, wherein the DRM server receives DRM client information.

5. The method according to claim 4, wherein the client information is which client servers are operating.

6. The method according to claim 1, further comprising determining which DRM client is most suitable to support the request.

7. The method according to claim 6, wherein the step of determining is based upon a client performance characteristic.

8. The method according to claim 7, wherein the characteristic is based on processing speed.

9. The method according to claim 1, further comprising monitoring the application resource to ensure its operability.

10. The method according to claim 9, further comprising polling by the DRM server to the application resource to obtain operability status.

11. The method according to claim 9, further comprising polling by the application resource to the DRM server to obtain operability status.

12. The method according to claim 11, further comprising denying a request for the application resource based upon non-operability of the application resource.

13. A dynamic resource mapping (DRM) server component, comprising:
a client side DRM process for collecting machine specific performance characteristics;
a client/server protocol to allow communication of machine specific process characteristics between the DRM server component and the client side DRM process; and
a DRM protocol to allow a client to request an application resource by name and the DRM server to return a selected address of a client, the selection made based upon collected machine specific performance characteristics of at least one client.

14. The system according to claim 13, wherein the DRM server grants a request to the application resource based upon its operability.

15. The system according to claim 14, wherein the operability of the application resource is determined by the DRM server polling the application resource.

16. A dynamic resource mapping system (DRM) server component, comprising:
means for receiving a DRM request for an application resource, including a process or data handler, from a user;
means for selecting a suitable DRM client from among plural registered DRM clients having the application resource to support the user request; and
means for providing an address corresponding to the application resource on the selected DRM client to the user.

17. The system according to claim 16, further comprising means for accepting a DRM registration of a DRM supported client.

18. The system according to claim 16, further comprising means for determining which DRM client is most suitable to support the request.

19. The system according to claim 18, wherein the means determining is based upon a client performance characteristic.

20. The system, according to claim 19, wherein the characteristic is based on processing speed.

21. The system according to claim 16, further comprising means for monitoring the application resource to ensure its operability.

22. The system according to claim 21, further comprising means for polling by the DRM server to the application resource to obtain operability status.
